(19) United States
(12) Patent Application Publication
(10) Pub. No.: US 2004/0057049 A1
(43) Pub. Date: Mar. 25, 2004

(54) Micromechanical monochromator with integrated slit aperture for microspectrometers in the UV, visible and infrared range

(75) Inventors: Reinhard Bruch, (US); Uwe Fritzsch, (US); Thomas Gessner, (US); Thomas Otto, (US); Volker Stock, (US)

Correspondence Address: Reinhard Bruch, 709 Putnam Drive, Reno, NV, 89503, US

(73) Assignee: Applied Photonics Worldwide, Inc., Reno, NV

(21) Appl. No.: 10/668,025

(22) Filed: Sep. 19, 2003

Related U.S. Application Data
(60) Provisional application No. 60/412,535, filed on Sep. 20, 2002.

(51) Int. Cl. G01J 3/28

(52) U.S. Cl. 356/328; 356/334

(57) ABSTRACT

The present invention relates to different types of micromirror spectrometers using MEMS (Micro Electro Mechanical Systems) for various applications in the UV, VIS, NIR and MIR wavelength regions. The invention enables a wavelength selection using micro scanning mirror and integrated grating on a much smaller scale than previously encountered conventional diffraction grating monochromators. Especially small designs are obtained via simultaneous usage of collimation optics for both spatial filters, by using entrance and exit slit apertures, which are located very close together. Until now, the spatial filters themselves are not part of the miniaturization. The utilization of the precision from this technology allows for reproducible slits with defined geometries and surface roughness and accurate spatial classification towards the rotation axis of the diffraction grating. Therefore the assembly and adjustment effort of the monochromator is reduced. Due to the option of additional slit apertures, several independent monochromator channels with crossed beam paths can be created; whereas all remaining optical elements (diffraction grating and collimator optic) are utilized together. Such additional channels can serve, for example, as reference measurements of a radiation source, or enable the direct optical control of the grating torsion angle as a monitoring channel. The goal of the invention is to define a simple design and arrangement for monochromators based upon micromechanical elements, which avoids all disadvantages described above.

### CROSS REFERENCE TO RELATED APPLICATIONS

This application claims priority of, and expressly incorporates by reference, U.S. Provisional Application Serial No. 60/412,535 filed Sep. 20, 2002.

### FIELD OF THE INVENTION

The invention relates to the domain of optical spectroscopy with the intention to simplify the construction and arrangement of micromechanical monochromators based on MEMS (Micro Electro Mechanical Systems) technology and its applications. This invention allows for an ultracompact, lightweight, high resolution and reproducible construction of a micro mechanical spectrometer working in the UV, Visible, and Infrared Range.

### BACKGROUND

In U.S. Pat. No. 4,867,532, Stanley described a wavelength selection device having a diffraction grating mounted on a torsion member. He also claimed a monolithic torsion diffraction grating, which is directly integrated on the surface of the monolithic movable torsion element, with the grating parallel to the mechanical axis. However no claims have been made about the wavelength resolution and efficiency of this device.

Reffner et al. in U.S. Pat. No. 4,922,104 and Eguchi et al. in U.S. Pat. No. 4,922,104 disclose an infrared micromirror spectrometer attached to a microscope apparatus, which is suitable for accurately identifying the material at a microfine portion. Although this device enables high sensitivity spectral measurements the system is highly complex and is not suitable for remote handheld operations. Furthermore, Zavracky proposes in U.S. Pat. No. 5,909,280 a method of monolithically fabricating a microspectrometer with an integrated detector. This microspectrometer can be integrated into a sensor system to measure the optical and physical properties of solids and fluids. The disadvantage of this instrument is that its detection sensitivity is limited.

### SUMMARY OF AT LEAST ONE EMBODIMENT OF THE INVENTION

### Brief Description of One Embodiment of the Present Invention

The present invention may provide scanning micromechanical monochromators/spectrometers with a dispersive controllable element that is either built with a monolithic torsion mirror with a related fixed diffraction grating or with a monolithic torsion diffraction grating, and a fixed spatial filter at the entrance and exit slit. In addition to this important physical miniaturization, a significant simplification of the spectrometers beam path is gained by using advanced MEMS (Micro Electro Mechanical Systems) technology.

The above description sets forth, rather broadly, a summary of at least one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a conventional micro mechanical monochromator in autocollimation assembly with torsion mirror, fixed diffraction grating, and off-axis parabolic reflector.

FIG. 2 is substantially a monochromator like FIG. 1 with collimator lens and torsion diffraction grating.

FIG. 3 is substantially a cross sectional view of the rotation axis for a monochromator according to the invention, with slit apertures on the axis of the torsion diffraction grating.

FIG. 4 is substantially a schematic side view of the design according to FIG. 3.

FIG. 5 is substantially a topological reproduction of exemplary designs of slit apertures on the monolithic body of the torsion diffraction grating.

FIG. 6 is substantially a schematic optical system layout for micromirror spectrometer with an oscillating scanning mirror and diffraction grating combination.

### DESCRIPTION OF CERTAIN EMBODIMENTS OF THE PRESENT INVENTION

In the following detailed description of certain embodiments of the present invention, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

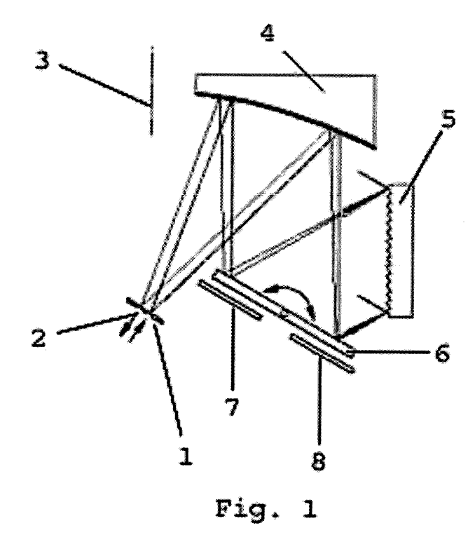

Five exemplary approaches to optical arrangements for the measurement of spectra in specific regions are shown in FIGS. 1 through 5. The invention relates to spectrometers in general (covering the UV, Visible and Infrared range), which are designed with the microspectrometer according to the invention as well as radiation detectors for the measurement of the decoupled monochromatic radiation and a related analyzing unit. The drawings are schematic and the diffraction angles are illustrative and not exact.

FIG. 1 is a schematic optical layout according to the principle of the present invention. Radiation in the form of photons, for example an infrared beam, proceeds from a light source and is collimated through the entrance slit 1 and then strikes a curved parabolic mirror which makes the polychromatic light beam parallel. In another embodiment of this invention a micromirror 6 scans the input light over a fixed diffraction grating 5, which disperses the spectrum. The spectrum is then reflected back to the detector plane (exit slit 2). One specific feature of the layout is that the MEMS oscillating micromirror is separate from the grating. Moreover, in this design, the slit apertures 1 and 2 are a part of the miniaturization and need not be adjusted separately. In addition, the spectrum is scanned via tilting motion of the micromechanical torsion element 6. Design and function of such micromechanical diffraction gratings are known from U.S. Pat. No. 4,867,532. However, variations in the options of the drive (electrostatic, electromagnetic, resonance driven, capacitive controlled) are further design criteria of the invention. The arrangement of the optical elements of the example in autocollimation is no restriction to the invention.

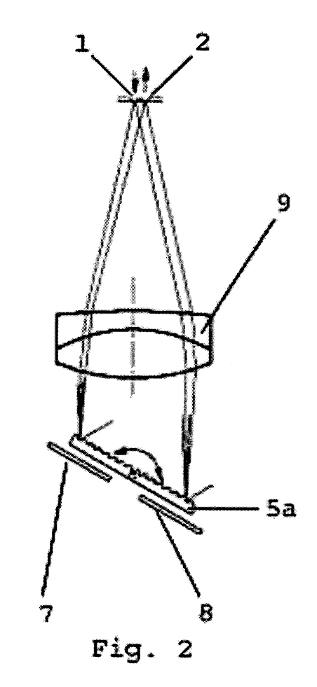

FIG. 2 reveals another scheme of the construction and the function of the monochromator in autocollimation as shown in FIG. 1 with achromatic collimator lens 9 and integrated torsion diffraction grating 5a. The wavelength selection device 5a is comprised of a diffraction grating mounted to a torsion micromirror. A pair of electrodes 7, 8 is responsive for the electrostatic deflection. The micromechanical diffraction grating in the example consists substantially of an electrode mounting on the backside with electrodes 7, 8. A controllable power supply generates defined electrode potentials in order to accelerate the torsion element by electrostatic forces. The fixed entrance spatial filter generates the parallel polychromatic radiation. The desired parallel monochromatic partial radiation is selected and decoupled due to the fixed exit spatial filter. The spatial filters contain collimation optics to guide and focus the radiation, like mirrors 4 or lenses 9, where small apertures are located in their focus. These are usually slit apertures 1, 2 and/or optical waveguides and/or detectors.

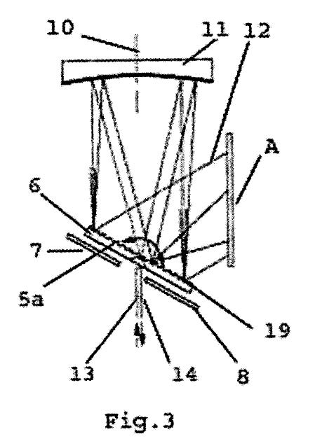

FIG. 3 is a preferred embodiment of this invention consisting of the optical beam path of the exemplary monochromator. It basically consists of a movable integrated diffraction grating torsion mirror 5a, with electrodes 7, 8 and a common spherical collimator mirror 11 with mirror's optical axis 10, where 12 represents the zero order of diffraction which is absorbed by surface screen A. With the help of the dispersive element 5a, parallel polychromatic radiation is dispersed spatially into almost parallel monochromatic radiation, while the direction of this monochromatic radiation is controlled via tilting. Due to the small numerical aperture, the spherical aberration of the spherical collimator mirror 11 is relatively small, so that an expensive parabolic reflector is not necessary. The polychromatic radiation to be analyzed by the optical waveguide 13, located on the backside of the entrance slit aperture passes the aperture and arrives diverged at the collimator mirror. After reflection from the collimator mirror the almost parallel radiation bundle illuminates the diffraction grating 5a. In this case the incidence angle onto the diffraction grating is determined by the actual angle position of the torsion element 6. The radiation part of the zero diffraction order 12 leaves the diffraction grating towards the screen A and will be absorbed. According to the diffraction equation and the angle position of the torsion element, the diffracted monochromatic radiation parts from the wavelength dependent direction and leaves the diffraction grating as a parallel bundles towards the collimator mirror 11. The collimator mirror then reflects and focuses this partial radiation in different wavelength dependent focal points. Now the exit slit aperture 19 selects partial radiation of a narrowed wavelength range and redirects it towards the exit optical waveguide 14.

An additional design of the invention is defined by the replacement of the described slit apertures using sufficiently large slits in the monolithic base body of the torsion element, whereas the aperture slit is replaced with the front of an optical waveguide or by a suitable small radiation detector in the focus of the collimator optics.

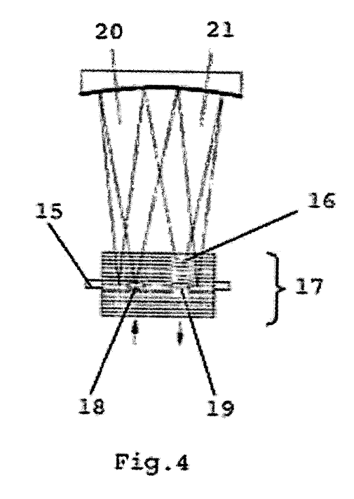

FIG. 4 is a schematic side view of the design according to FIG. 3. In this case the slit apertures 18, 19 are arranged on the rotation axis of the torsion grating 6 as previously utilized in FIG. 3. The space between both back electrodes 7, 8 can be used to guide the polychromatic radiation to the slit apertures or to extract the monochromatic radiation, respectively. Furthermore, the spatial location of the slit apertures always remains consistent and the slits remain exactly in the focus point of the collimator mirror 11. In the preferred example, entrance and exit slit apertures 18, 19 are designed within the area of the diffraction grating 5a. One result of the inventive slit design is that the parallel radiation reflected from the collimator mirror propagates very close to the axis in relation to the optical axes 20, 21, which are defined by the focus according to the entrance slit apertures 18, 19.

Another advantageous development of the invention consists of monolithic body 17, torsion spring 15, torsion element of the torsion diffraction grating 6, planar reflector and electrodes of the electrostatic drive 7, 8 with a fixed external diffraction grating 5 instead of the torsion diffraction grating, while the entrance and exit slit apertures are arranged on the monolithic body 17 of the torsion mirror.

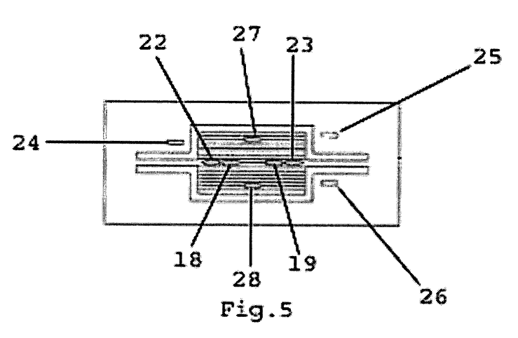

FIG. 5 is an extension of FIGS. 3 and 4 where optical waveguides 13, 14 are discussed, which are fed directly through to the backside of the slit apertures 18, 19. In further designs of the invention the slit aperture can be directly confronted with the radiation to be analyzed by means of a prefixed optic or a Light Emitting Diode (LED) directly fixed at the electrode mounting as a monitor radiation source. Via design of further slit apertures 18, 19, 22, 23, 24, 25, 26, 27, 28 within the monolithic body 17 of the torsion diffraction grating—many more configurations can be achieved as schematically shown in FIG. 5. The present invention also relates to several independent simultaneous monochromator channels, which can be created as diverse designs.

One application example of the monochromator for transmission measurements includes slit apertures 18, 19 of the sample-sided first monochromator channel, slit apertures 22, 23 of another sample-sided monochromator channel, furthermore slit apertures 27, 28 of a reference channel for radiation source compensation, as well as slit apertures 24, 25 (in front of LED and detector) of a monitor channel for phase control of the angle movement of the torsion grating.

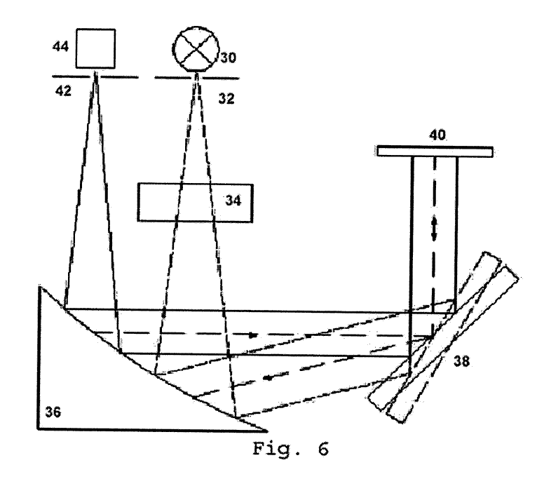

FIG. 6 shows the applications of our microspectrometer micro scanning mirror 38. The mirror is manufactured using micro system technology and operates in a resonance mode. In addition the mirror is driven by a controlled alternating high voltage signal (approximately 500 Volts). The polychromatic radiation from a broadband IR light source 30 is focused onto the spectrometer entrance slit 32. Then a paraboloidal reflector 36 is used to produce a parallel beam to illuminate the micro mirror 38 and diffraction grating 40. The radiation of the first order of diffraction from the grating 40 is then focused via the paraboloidal reflector 36 onto the detector slit 42. The analyzed wavelengths are essentially determined by the incidence angle of the radiation onto the grating 40 according to the temporary mirror angle. Consequently, the spectrum is continually scanned over the detector slit 42, as a function of the mirror rotation angle. The NIR (Near Infrared) and MIR (Middle Infrared) radiation, modified by the sample interaction, is detected and amplified by the IR detector system 44. Due to the control of the mirror angle the observed signal can be assigned to the respective wavelength. From the measured spectra, characteristic molecular band positions and intensities can be determined for characterization of the sample 34.

These types of ultracompact micromirror spectrometers can be applied to many fields, namely: (i) non invasive medical diagnostics (ii) monitoring of biochemical processes (iii) surface diagnostics of numerous materials (iv) diagnostics of human tissues (v) characterization of the quality of food (vi) pharmacological products and cosmetics (vii) characterization and treatment of aging of skin (viii) detection of toxic gases and fluids (ix) biological warfare agents and bacterial spores in the MIR range. This approach utilizes extinction and scattering measurements to characterize the spectral fingerprints of bacterial particles.

### CONCLUSION

Although the description above contains many specifications, these should not be construed as limiting the scope of the invention but as merely providing illustrations of certain embodiments of this invention. Thus, the scope of the invention should be determined by the appended claims and their legal equivalents rather than by the examples given.

What is claimed is:

1. A scanning micromechanical monochromator with integrated slit apertures for spectroscopic analysis, said micromirror spectrometer system comprising:
(i) a radiation source;
(ii) a controllable diffraction grating, to reflect or transmit light;
(iii) a scanning mirror based on MEMS technology;
(iv) a micromirror driving unit for oscillating the scanning mirror in different wavelength regions;
(v) a parabolic or spherical mirror or achromatic lens positioned to focus the light beam;
(vi) entrance and exit spatial filters consisting of fixed collimator optics and slit apertures, defined as at least one of the slit apertures is part of the monolithic body of the device;
(vii) a detector for detecting radiation reflected or transmitted from the sample;
(viii) a micromirror spectrometer with torsion mirror and an integrated grating receiving spectroscopic signals from said sample and operated in different wavelength regions; and
(vi) a sample positioned in the path of the analyzing light beam.

2. An ultra-compact micromirror spectrometer according to claim 1 comprising of at least one of the slit apertures in the torsion element is located within the diffraction grating preferably on its rotational axis. A combined mirror torsion diffraction grating based on MEMS technology where the grating disperses the polychromatic light and the torsion mirror scans the wavelength.

3. A micromirror spectrometer according to claim 2, consisting of the collimator optics of at least one spherical mirror and a combined mirror torsion diffraction grating.

4. A micromirror spectrometer according to claim 3, defined as, that the surface of the torsion element on those wavelengths specific arrival points of the focused monochromatic partial radiation outside of the exit slit aperture is locally designed as a mirror; and/or a screen within the radiation path of the reflected partial radiation or the zero diffraction order is mounted.

5. A micromirror spectrometer according to claim 4, consisting of one secondary entrance slit aperture and several secondary exit slit apertures within the monolithic body of the torsion diffraction aperture for simultaneous selection of the monochromatic partial radiation of different wavelength intervals.

6. A micromirror spectrometer according to claim 5, comprising a monolithic body of the torsion diffraction grating and further slit apertures designed for the purpose, that groups of these slit apertures by mutual use of the collimator optics and the diffraction grating, form several from each other independent monochromator channels with crossing beam paths, while one of the additional monochromator channels is used for phase control of the angle movement of the torsion grating as an option.

7. A micromirror spectrometer according to claim 6, wherein, the torsion diffraction grating is replaced by a controllable micromechanical torsion mirror with external, fixed diffraction grating, while at least one of the slit gratings is part of the monolithic body of the micro mechanical torsion mirror or is optionally integrated as a fixed element in the body.

8. A micromirror spectrometer according to claim 7, where instead of at least one of the monolithic integrated slit grating a sufficient large slit within the monolithic body of the micro mechanical torsion grating respectively torsion mirror is arranged, while related optical wave guides and/or radiation detectors have a sufficiently small aperture area, being part of the space filter.

9. A handheld micromirror spectrometer apparatus according to claim 1 comprising of a radiation source, a micromirror spectrometer with integrated slit aperture, detectors, accessories and analyzing unit, for analysis of human skin in vivo using a near infrared (NIR) or middle infrared (MIR) radiation source and infrared sensitive diffraction grating, optics and detectors.

10. A handheld micromirror spectrometer device according to claim 9, for online remote detection of bioaerosols, biological agents and toxic gases using a tunable infrared light source including a laser.
